(19) United States
(12) Patent Application Publication
(10) Pub. No.: US 2009/0032340 A1
(43) Pub. Date: Feb. 5, 2009

(54) Method and Apparatus to Minimize Re-Leveling in High Rise High Speed Elevators

(76) Inventor: Rory Smith, El Cajon, CA (US)

Correspondence Address: FROST BROWN TODD, LLC, 2200 PNC CENTER, 201 E. FIFTH STREET, CINCINNATI, OH, 45202, US

(21) Appl. No.: 12/183,534

(22) Filed: Jul. 31, 2008

Related U.S. Application Data
(60) Provisional application No. 60/953,031, filed on Jul. 31, 2007.

(51) Int. Cl. B66B 5/18; F16D 65/092

(52) U.S. Cl. 187/250; 188/73.31

(57) ABSTRACT

One embodiment disclosed comprises a roller guide device comprising at least one roller and a respective braking apparatus for the roller. The braking apparatus in this embodiment comprises a disc brake. In this same embodiment, the disc brake performs a braking operation by pressing a pair of pads on both sides of a roller. The disc brake may be supported by the base of the roller guide device, and comprise a single-piston mechanism that affects movement of the pair of pads.

### PRIORITY

The application claims priority from the disclosure of U.S. Provisional Patent Application Ser. No. 60/953,031, entitled “Method and Apparatus To Minimize Re-Leveling in High Rise High Speed Elevators,” filed Jul. 31, 2007, which is herein incorporated by reference in its entirety.

### FIELD OF THE INVENTION

The present disclosure relates, in general, to elevators and a guide device for an elevator having at least one roller and a braking apparatus.

### BACKGROUND OF THE INVENTION

Rope stretch is a problem in some elevator systems, and is generally a larger problem in high rise buildings. Rope stretch may occur when passengers depart or enter an elevator. The sudden fluctuation in weight in the elevator car reduces or increases the tension in the ropes. This change in tension may cause the elevator to move. Generally, changes in rope tension affect longer ropes more than shorter ropes, For example, one person entering an elevator cab with 1000 feet of rope may cause more rope stretch compared to the same person entering the same elevator cab having only 100 feet of rope.

Commonly, an elevator system comprises an elevator car and a counterweight, each suspended on opposite ends of hoist ropes which are disposed in an elevator hoistway. This elevator system also typically includes at least two sets of guide rails extending the length of the elevator hoistway, with each set of guide rails being disposed on opposite sides of the hoistway. The guide rails guide a plurality of roller guides attached to the elevator car. Besides guiding the elevator car up and down the hoistway, the roller guides ensure a smooth ride of the elevator car by isolating the elevator car from excitation and leveling the elevator car within the hoistway.

In the past, overcoming rope stretch may have required adding additional hoist ropes to the elevator system. Increasing the number of hoist ropes more greatly spread the weight being supported by the hoist ropes. Normally, elevator systems use a number of hoist ropes equal to the number of compensation ropes. Compensation ropes are responsible for supporting the weight of the compensation sheave. Therefore, adding more hoist ropes required adding more compensation ropes.

The natural frequency of an elevator rope is a function of its tension and the mass it is supporting. Commonly, compensation ropes have a low natural frequency because they support a low amount of mass. Ropes having a low natural frequency may have a frequency similar to the frequency of building sway. Resonance may occur where the frequency of a rope is the same as that of the building. The resonance may cause the ropes to strike the walls and elevator doors. Therefore, adding more compensation ropes, such as when trying to minimize the effects of elevator stretch, may cause more resonance due to it lowering the natural frequency of each compensation rope.

A better system for limiting and controlling movement of an elevator car is desired. While a variety of systems and configurations have been made and used that relate to this purpose, it is believed that no one prior to the inventor has made or used the invention described herein.

### BRIEF DESCRIPTION OF THE DRAWING

The accompanying drawings incorporated in and forming a part of the specification illustrate several aspects of the present invention, and together with the description serve to explain the principles of the invention; it being understood, however, that this invention is not limited to the precise arrangements shown. In the drawings, like reference numerals refer to like elements in the several views. In the drawings:

FIG. 1 illustrates a perspective view of an exemplary elevator system.

FIG. 2 illustrates a perspective view of a first exemplary roller guide device.

FIG. 3 illustrates a first side view of the roller guide device of FIG. 2.

FIG. 4 illustrates a second side view of the roller guide device of FIG. 2.

FIG. 5 illustrates a top view of an exemplary roller guide device.

FIG. 6 illustrates a side view of the exemplary roller guide device of FIG. 5.

FIG. 7 illustrates a perspective view of an exemplary roller guide device.

FIG. 8 illustrates a perspective view of an exemplary disc brake.

### DETAILED DESCRIPTION OF THE INVENTION

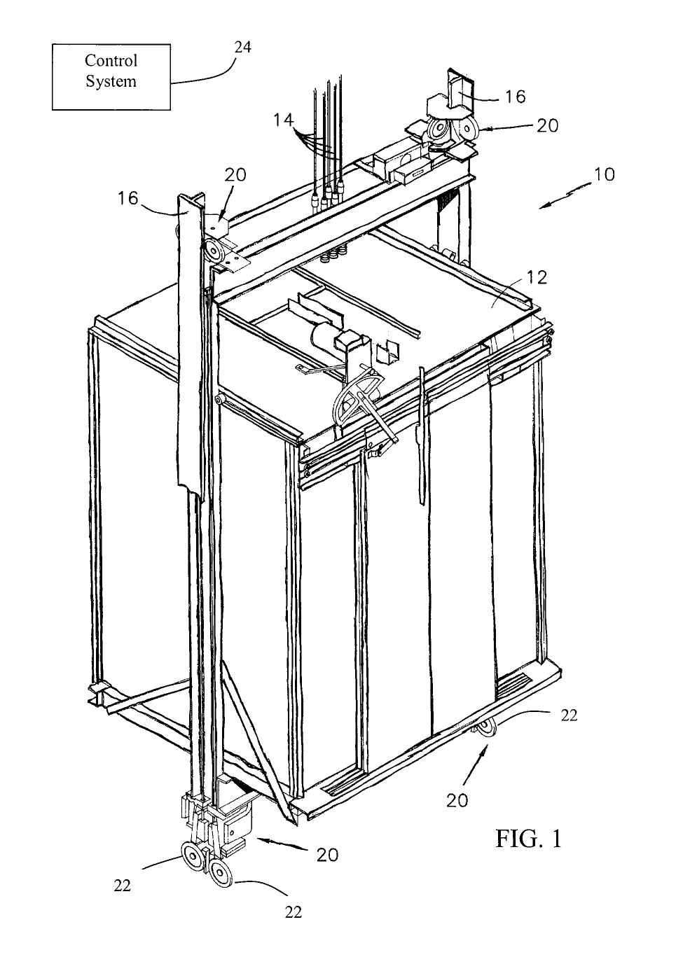

Referring now to the drawings in detail, wherein like numerals indicate the same elements throughout the views, FIG. 1 depicts an exemplary elevator system (10). Referring to FIG. 1, elevator system (10) includes an elevator car (12) suspended from a plurality of hoist ropes (14) and riding along guide rails (16). A plurality of roller guide assemblies (20) engage guide rails (16). In operation, as elevator car (12) moves up and down the hoistway, each roller guide assembly (20) engages the corresponding guide rail (16) and is guided thereby. Each roller (22) rotates about an axle as each roller guide assembly (20) rides along guide rails (16). Elevator system (10) is governed by control system (24). Elevator system (10) represents only one embodiment of an elevator system. Various elevator and control systems are known in the art. The following disclosure may be incorporated into any suitable elevator system, or control system therefor.

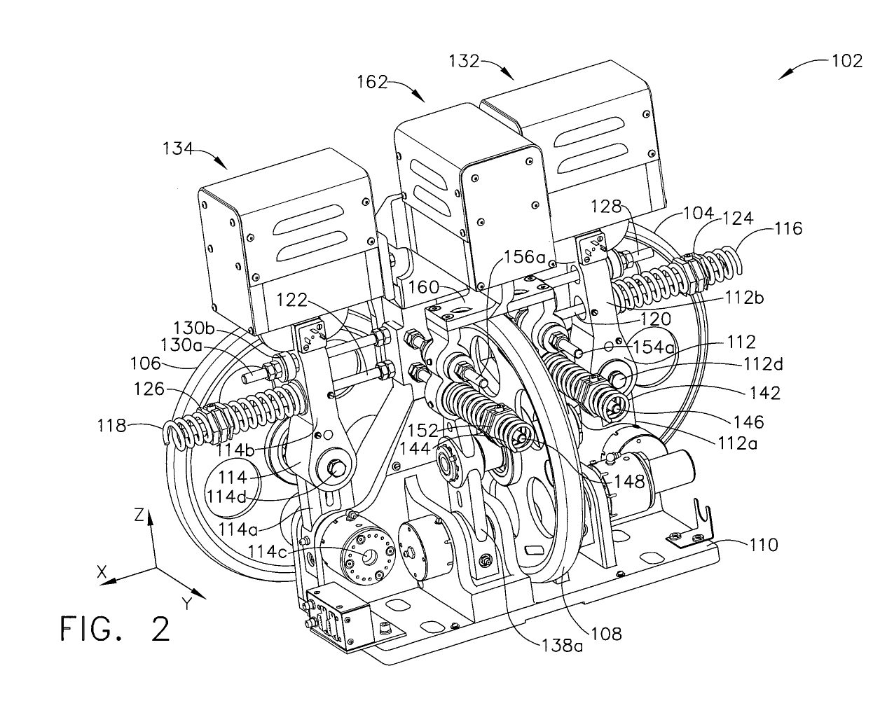

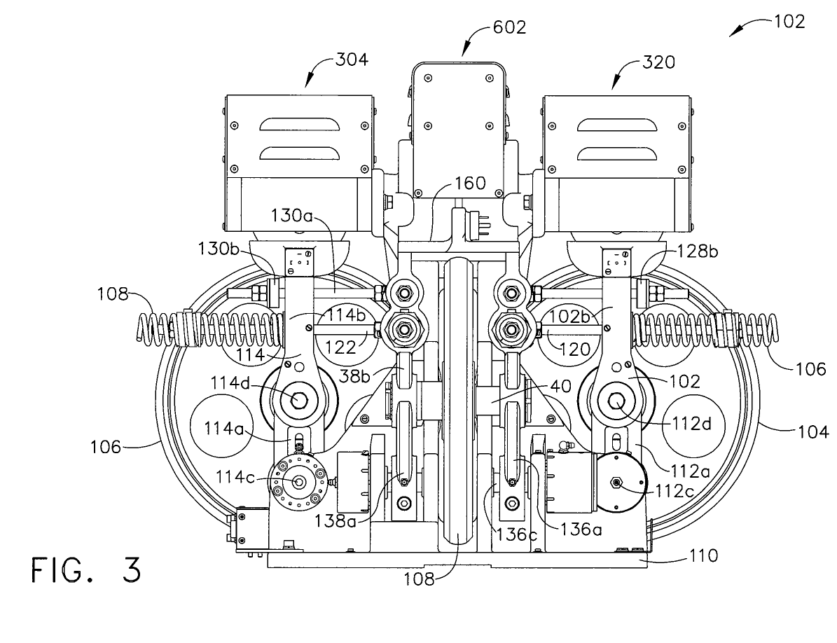

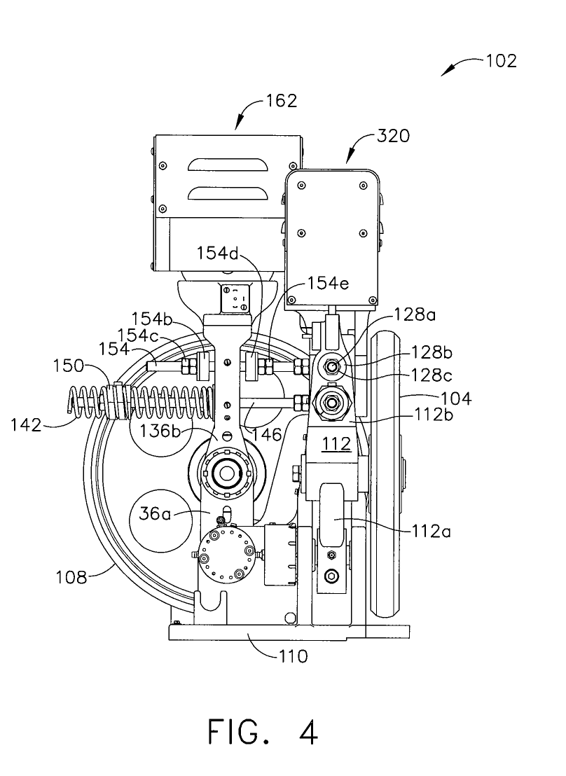

As seen in FIGS. 2-4, there is shown an exemplary roller guide assembly indicated generally at (102). A plurality of roller guide assemblies (102) may be used on an elevator car, as shown for example in FIG. 1. Roller guide assemblies (102) may be used in spaced apart locations to engage guide rails (not shown). Likewise, a single roller guide assembly (102) may be used on an elevator car.

As seen in FIGS. 2-4, roller guide assembly (102) includes two spaced apart rollers (104) and (106) lying in the XZ plane, and roller (108) lying in the YZ plane. The construction of rollers (104), (106) and (108) are similar, with rollers (104) and (106) mirroring each other. Roller guide assembly (102) includes base (110) which is mounted directly or indirectly to an elevator car similar to that shown in FIG. 1. Base (110) carries rollers (104), (106) and (108).

Roller (104, 106) are respectively engaged with lever arms (112, 114). Lever arms (112, 114) respectively comprise lower lever arm (112a, 114a) and upper lever arm (112b, 114b). Each lower lever arm (112a, 114a) is bearingly carried by base (110), pivotable about a respective pivot axis (112c, 114c). Each lever arm (112, 114) rotatably carries rollers (104, 106) respectively, bearingly supported thereby about respective roller shafts (112d, 114d) (not seen completely). Each upper lever arm (112b, 114b) is resiliently urged inwardly in the direction toward the guide rail (not shown) and therefore toward each other by respective biasing members (116, 118) carried by respective cantilevered shafts (120, 122) supported by base (110), which extend through respective openings of upper lever arms (112b, 114b). Although biasing members (116, 118) are illustrated as springs, any suitable biasing device may be used. In the embodiment depicted, the force exerted by biasing members (116, 118) against upper lever arms (112b, 114b) (and resisted by the guide rail through rollers (104) and (106)) may be adjusted by the position of members (124, 126). Outward movement of lever arms (112, 114) is limited by restraints (128, 130) respectively.

Each respective restraint (128, 130) includes cantilevered shaft (128a, 130a) extending from base (110) and rubber bumper (128b, 130b) the positions of which can be adjusted by positioning retainers (128c, 130c) illustrated as nut pairs. Restraints (128, 130) may be of any suitable construction or components. At the respective distal ends of lever arms (112, 114) are disposed respective actuators generally indicated at (132, 134) the details of which will be discussed later. Although in the embodiment depicted each roller (104, 106) has a respective actuator (132, 134) which function independent of each other, the movement of rollers (104, 106) could be made interdependent, with a single actuator disposed to dampen the oscillations acting on the frame.

Still referring to FIGS. 2-4, the configuration of the supporting structure for roller (108) is similar to that described above. Roller (108) is supported on either side by two spaced apart lever arms (136, 138) depicted as a respective assembly of lower lever arm (136a, 138a) and upper lever arm (136b, 138b).

Each lower lever arm (136a, 138a) is bearingly carried by base (110) and pivotable about a respective pivot axis (136c) and (138c). Each lever arm (136, 138) cooperatively rotatably carries roller (108), bearingly supported thereby about roller shaft (140) with roller shaft (140) being bearingly supported at each end by lever arms (136, 138) respectively. Each upper lever arm (136b, 138b) is resiliently urged inwardly in the direction toward the guide rail (not shown) by respective biasing members (142, 144). Biasing members (142, 144) are carried by respective cantilevered shafts (146, 148) supported by base (110) which extend through respective openings of upper lever arms (136b, 138b). Although biasing members (142, 144) are illustrated as springs, any suitable biasing device may be used.

In the embodiment depicted, the force exerted by biasing members (142, 144) against upper lever arms (136b, 138b (and resisted by the guide rail through roller (108)) may be adjusted by the position of members (150, 152). Outward and inward movement of lever arms (136, 138) is limited by restraints (154, 156) respectively. Each respective restraint (154, 156) includes cantilevered shaft (154a, 156a) extending from base (110) and rubber bumpers (154b, 156b) on the outside the positions of which can be adjusted by positioning retainers (154c, 156c) illustrated as nut pairs, and (154d, 156d) on the inside the positions of which can be adjusted by positioning retainers (154e, 156e) illustrated as nut pairs. Restraints (154, 156) may be of any suitable construction or components. The respective distal ends of lever arms (136, 138) are connected to each other through cross member (160) causing each lever arm (136, 138) to remained in proper alignment with the other. Actuator (162) is disposed at cross member (160).

Actuators (132, 134, 162), for example motors or solenoids, may augment or diminish the force of biasing members (116, 118, 142, 146, 148). Actuators may augment or diminish the spring force on the guiding devices of the active guide in response to a control system that determines the dampening requirements of the system to counteract the accelerations of the elevator system to create zero acceleration in the car. The control system may use sensors, such as accelerometers to detect acceleration of the elevator car and actuators to effect the dampening requirements.

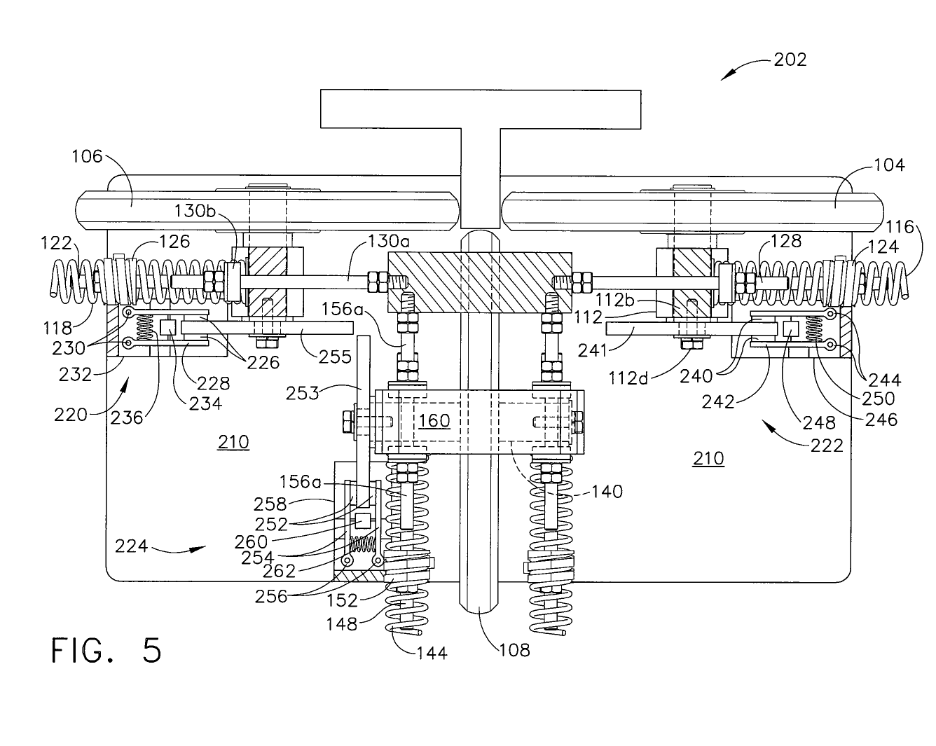

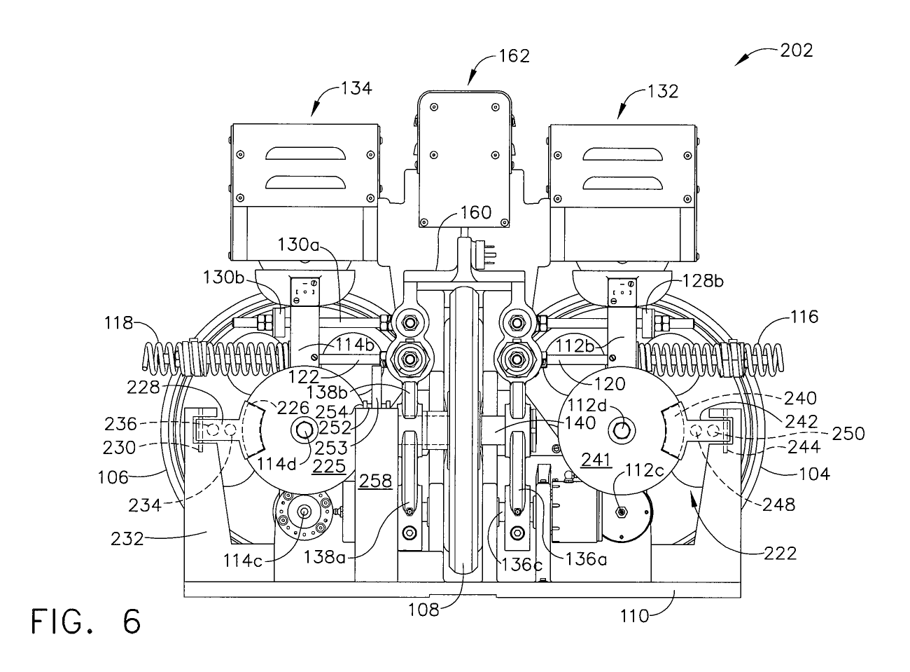

FIGS. 5-6 depict roller guide assembly (202) which comprises roller guide assembly (102) shown in FIGS. 2-4 further comprising brake devices (220, 222, 224). Brake devices (220, 222, 224) comprise exemplary disc brakes. More specifically, brake device (220, 222, 224) respectively engages a brake disc (225, 241, 253). Brake disc (225, 241, 253) is respectively in communication with roller (106, 104, 108) in a manner whereby preventing rotation of brake disc (225, 241, 253) prevents rotation of roller (106, 104, 108). This may or may not be a direct connection respectively between brake disc (225, 241, 253) and roller (106, 104, 108).

Brake device (220, 222, 224) further comprises a pair of pads (226, 240, 252). Brake pads (226, 240, 252) are operable to engage brake disc (225, 241, 253). pads (226, 240, 252) are supported and affixed to a pair of caliper arms (228, 242, 254). Caliper arms (228, 242, 254) may at least be respectively directed in an axial direction towards and away from brake disc (225, 241, 253). Caliper arms (228, 242, 254) are rotatably supported by caliper pins (230, 244, 256). Caliper pins (230, 244, 256) permit caliper arms (228, 242, 254) to rotate in a direction around an axis represented by caliper pins (230, 244, 256).

A spring (236, 250, 262) has a plurality of ends with a first end respectively attached to a first caliper arm (228, 242, 254) and a second end attached to another caliper arm (228, 242, 254). Spring (236, 250, 262) is positioned proximal where caliper arms (228, 242, 254) respectively engage caliper pins (230, 244, 256). Spring (236, 250, 262) exerts a force directing caliper arms (228, 242, 254) in a direction opposite each other and away from brake disc (225, 241, 253). A solenoid (234, 248, 260) is respectively positioned between the pair of caliper arms (228, 242, 254). Solenoid (234, 248, 260) is positioned more proximal brake disc (225, 241, 253) compared to spring (236, 250, 262). Solenoid (234, 248, 260), in its inactive state where no electric current is running through it, does not inhibit the movement of caliper arms (228, 242, 254). Solenoid (234, 248, 260) in its active state where electric current is running through it draws caliper arms (228, 242, 254) towards each other, and to respectively engage brake disc (225, 241, 253). Caliper arms (228, 242, 254) and caliper pins (230, 244, 256) are respectively supported by a mount (236, 246, 258). Mount (236, 246, 258) is fixably secured to, and supported by base (210).

As mentioned earlier, other disc brakes are known in the art. Examples include a single-piston disc brake or a multi-piston disc brake. Also, self-centering and self-adjusting disc brakes are known in the art. Any suitable disc brake may be used with roller guide assemblies (102, 202) shown in FIGS. 2-6. Yet further, any suitable actuating member such as a motor, a piston, or a solenoid may be used to operate the disc brake. The actuator may communicate with a control system governing operation of the elevator whereby the control system effectively operates a disc brake. Effective operation of the disc brake may include applying the disc brake as an elevator is stopping as well as while the elevator is stopped. The control system may use sensors, such as accelerometers, to otherwise monitor the movement of the elevator and effectively manage the operation of the disc brakes.

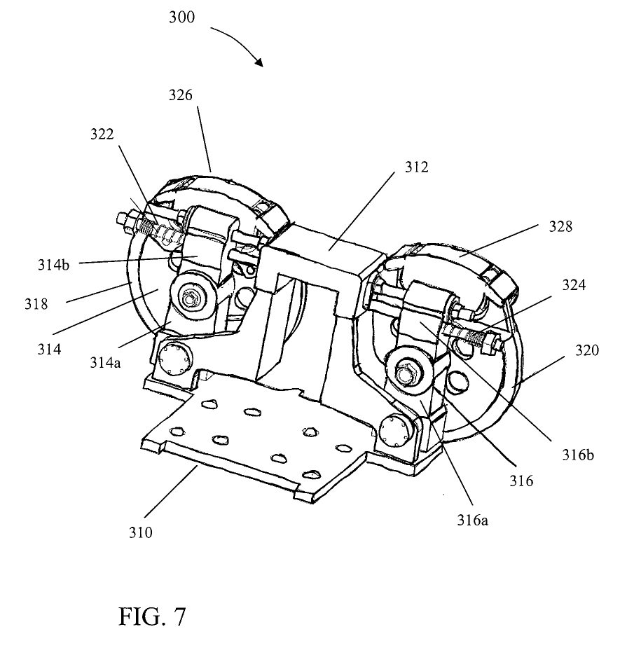

An alternative embodiment of a roller guide assembly is shown in FIG. 7. As shown in FIG. 7, roller guide assembly (300) comprises a base (310) supporting a housing (312). Housing (312) supports arms (314, 316) that respectively have a lower arm (314a, 316a) and an upper arm (314b, 316b). In the embodiment shown, lower arms (314, 316) are bearingly supported by housing (312). Each arm (314, 316) rotatably carries rollers (318, 320) respectively. Each upper arm (314b, 316b) is resiliently urged inwardly in the direction toward a guide rail (not shown) by biasing members (322, 324).

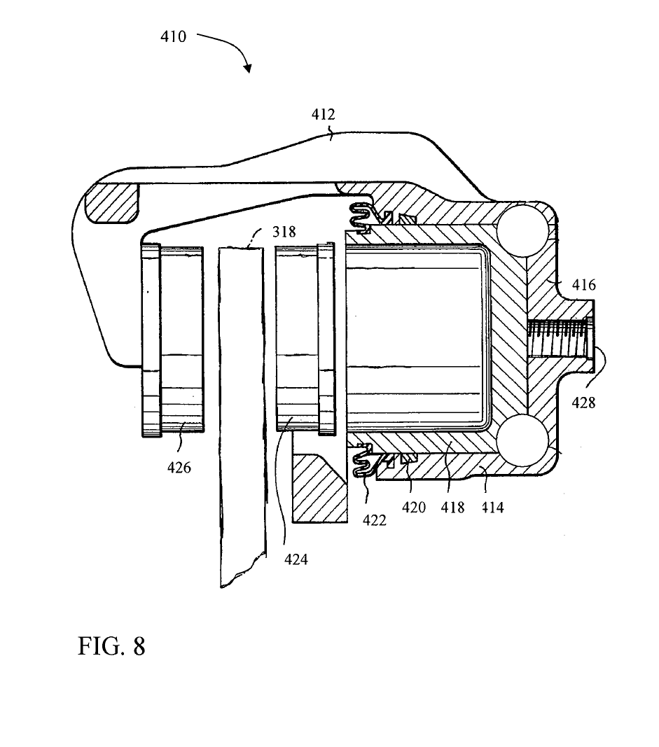

Housing (312) also respectively supports brake devices (326, 328). In the embodiment shown, brake devices (326, 328) respectively comprise a disc brake, such as that shown in FIG. 8. Brake devices (326, 328) are respectively operable to engage rollers (318, 320), and positioned proximal upper arms (314b, 316b). However, brake devices (326, 328) may be positioned in any suitable manner.

As mentioned earlier, a plurality of disc brakes are known in the art. Examples include a single-piston disc brake. Also, self-centering and self-adjusting disc brakes are known in the art. Any suitable disc brake may be used for brake devices (326, 328) with roller guide assembly (300). Yet further, any suitable actuating member such as a motor or solenoid may be used to operate brake devices (326, 328). Yet further, brake devices (326, 328) may be actuated mechanically, hydraulically, electromagnetically, pneumatically, or by using any other suitable method.

An exemplary disc brake (410) is depicted in FIG. 8. Disc brake (410) comprises a caliper (412), a cylinder (414) with a closed end (416) and integral with caliper (412), a piston (418) sealingly and slidably disposed in cylinder (414), a sealing member (420) mounting in the inner wall of the cylinder (414), a flexible cover (422) extending from the open end of the piston (418) to the entrance of cylinder (414), a pad (424) directly actuated by piston (418) and another pad (426) actuated by caliper (412). Roller (318, 320) may be disposed of between pads (424, 426) so that roller (318) is braked by pads (424, 426) when operating fluid is fed, through a fluid port (428) formed in cylinder (414), into an operating chamber defined between the bottom of cylinder (414) and the closed end of piston (418).

One method of operation for the embodiment of roller guide assembly (300) depicted in FIG. 7 includes the following. Roller guide assembly (300) may be configured with an actuator that communicates with a control system governing operation of an elevator whereby the control system effectively operates brake devices (326, 328). Effective operation of brake devices (326, 328) may include applying the disc brake as an elevator is stopping or while the elevator is stopped. The control system may use sensors, such as accelerometers to otherwise monitor the movement of the elevator and effectively manage use of the brake devices (326, 328).

More specifically, roller guide assembly (300) may be configured in an elevator system in a 400 meter building having 100 floors. Assume a passenger enters the elevator at the 99^{th} floor to travel to the ground floor. The elevator's control system may direct the elevator to stop and pick up the passenger at the 40^{th} floor. In one embodiment, the control system may direct the elevator car to decelerate at a certain speed before coming to a complete stop at the 40^{th} floor. The control system may limit rotation of rollers (318, 320) to achieve this deceleration. The control system of the elevator may be programmed to decelerate the elevator at a desired rate as well as to avoid decelerating above a maximum rate. The control system may direct brake device (326, 328) to respectively engage rollers (318, 320) to otherwise minimize the ability of the guide rollers to rotate. The engagement of the disc brake with the roller may or may not coincide with reducing the rotation of a driven sheave engaged with the hoist ropes supporting the elevator car.

Brake device (326, 328) may remain respectively engaged with roller (318, 320) during the elevator's deceleration until the elevator car reaches the 40^{th} floor (i.e. comes to a stop). Alternatively, brake devices (326, 328) may disengage rollers (318, 320) after a specified time period, when the elevator has reached a specified traveling speed, when the elevator has reach a certain distance from its planned stop, or based on some other factor.

Further, brake devices (326, 328) may remain engaged with rollers (318, 320) until the elevator stops at its destination, a certain time period after the elevator has stopped at its destination, or after the elevator resumes traveling. Any suitable method may be used for operating brake devices (326, 328). Various degrees of engagement may exist between brake devices (326, 328) and rollers (318, 320). For example, the initial force used to direct brake device (326, 328) against roller (318, 320) may be minimal to avoid stopping the elevator car too quickly. This initial force may be increased over time in order to increase the rate of deceleration of the elevator car.

Brake device (326, 328) may also engage roller (318, 320) after the elevator has stopped to address a call signal. For example, brake device (326, 328) may be directed to engage roller (318, 320) when the elevator has stopped at the 40^{th} floor to pick up the passenger. Brake device (326, 328) may remain engaged with roller (318, 320) for a specified time period, such as the minimum amount of time possible before the elevator resumes traveling. Likewise, brake device (326, 328) may remain engaged with roller (318, 320) until the elevator begins traveling to its next destination or shortly before that.

Please also remember that the various embodiments of roller guide assemblies disclosed in this application may be incorporated with other mechanisms, methods, devices, and techniques for governing the movement of elevator cars. For example, a roller guide assembly having a disc brake may be used in conjunction with a braking apparatus that is capable of attaching to the guide rails to prevent movement of the elevator car to which it is attached. Likewise, the various embodiments of roller guide assemblies may be incorporated into elevator control and sensing systems such as those seen in U.S. Pat. No. 6,256,368 and U.S. Pat. No. 4,337,846, to govern the movement of an elevator car. All of the systems disclosed or referenced herein may operate independently or in conjunction with each other, including each roller guide device.

The versions presented in this disclosure are examples. Those skilled in the art can develop modifications and variants that do not depart from the spirit and scope of the disclosed devices and methods. Thus, the scope of the invention should be determined by appended claims and their legal equivalents, rather than by the examples given.

What is claimed is:

1. A roller guide device for use in an elevator system, comprising:
(a) a base;
(b) at least one roller supported by the base; and
(c) a braking apparatus operable to respectively engage said at least one roller.

2. The roller guide device of claim 1 wherein said braking apparatus is respectively attached to said base.

3. The roller guide device of claim 1 wherein said braking apparatus is respectively attached to said at least one roller.

4. The roller guide device of claim 1 wherein said braking apparatus comprises a caliper and at least one pad respectively attached to said caliper.

5. The roller guide device of claim 4 further comprising an axis around which said at least one roller rotates, and wherein said at least one roller comprises a planar surface relatively perpendicular to said axis.

6. The roller guide device of claim 5 wherein said at least one pad is operable to engage said at least one planar surface.

7. The roller guide device of claim 6 wherein said caliper is operable to direct said at least one pad to engage said at least one planar surface.

8. The roller guide device of claim 7 wherein said caliper further comprises a solenoid positioned proximal said caliper wherein activating said solenoid directs said pad to engage said at least one planar surface.

9. A roller guide device for an elevator system including an elevator car and a guide rail system, comprising:
(a) a housing configured to attach to said elevator car;
(b) at least one roller supported by said housing; and
(c) a braking apparatus for selectably limiting the rotation of said roller.

10. The braking apparatus of claim 9 wherein said braking apparatus comprises a disc brake supported by said housing.

11. The braking apparatus of claim 10 wherein said disc brake comprises:
(a) a caliper; and
(b) at least one pad attached to said caliper.

12. The braking apparatus of claim 11 wherein said at least one pad is respectively positioned proximal said roller.

13. The braking apparatus of claim 12 wherein said at least one pad is operable to engage said roller.

14. The braking apparatus of claim 13 wherein said caliper further comprises a piston.

15. A roller guide device for an elevator system including an elevator car and a guide rail system, comprising:
(a) a housing configured to attach to said elevator car;
(b) at least one roller supported by said housing;
(c) a shaft having a first end rigidly connected to respective said roller, and an opposite end rotatably connected to said housing; and
(d) a braking apparatus supported by said housing and configured to respectively engage said shaft.

16. The roller guide device of claim 15 wherein said braking apparatus comprises a disc brake.

17. The roller guide device of claim 16 wherein the disc brake comprises:
(a) a first arm having an attached first pad wherein said first pad is capable of engaging said shaft;
(b) a second arm having an attached second pad wherein said second pad is capable of engaging said shaft; and
(c) a caliper attached to said housing, and supporting said first arm and said second arm.

18. The roller guide device of claim 16 wherein said first arm and said second arm respectively comprise a first pad and a second pad capable of engaging said at least one roller.

19. The roller guide device of claim 16 wherein said brake comprises a synthetic material.

20. The roller guide device of claim 16 wherein said brake is at least partly electromagnetically operated to engage said shaft.
